(19) United States
(12) Patent Application Publication
(10) Pub. No.: US 2026/0309073 A1
(43) Pub. Date: Oct. 8, 2026

(54) ENTRYWAY SYSTEM INCLUDING A DIVIDED VOLUTE TURBOCHARGER

(71) Applicant: BorgWarner Inc., Auburn Hills, MI (US)

(72) Inventors: Robert Malcolm Wallace, Candler, NC (US); Craig Andrew Colont, Candler, NC (US); Christopher Andrew Hauenstein, Etowah, NC (US); Ambrose Keith Nickson, Leeds (GB)

(21) Appl. No.: 19/200,875

(22) Filed: May 7, 2025

Related U.S. Application Data
(60) Provisional application No. 63/644,172, filed on May 8, 2024.

(51) Int. Cl. F02B 37/02; F01D 9/02; F01D 25/24

(52) U.S. Cl. CPC F02B 37/025; F01D 9/026; F01D 25/24; F05D 2220/40; F05D 2240/12

(57) ABSTRACT

An entryway system includes a divided volute turbocharger including a turbine housing, a first volute, a second volute, a turbine housing outlet, and a wall separating the first volute from the second volute. The wall has a first wall surface. The entryway system further includes a vane ring. The vane ring includes a vane divider wall further separating the first volute from the second volute. The vane divider wall has a vane divider surface facing the first wall surface. The vane ring includes a plurality of vanes coupled to the vane divider wall. The first wall surface and the vane divider surface define a restriction path between one another. At least a portion of the restriction path is non-parallel such that leakage of exhaust gas from one of the first and second volutes to the other of the first and second volutes is reduced.

### CROSS REFERENCE TO RELATED APPLICATIONS

This application claims priority to U.S. Provisional Patent Application No. 63/644,172, filed May 8, 2024, which application is incorporated herein by reference in its entirety.

### BACKGROUND OF THE DISCLOSURE

### 1. Field of the Disclosure

This invention relates generally to an entryway system including a divided volute turbocharger having variable turbine geometry.

### 2. Description of the Related Art

Turbochargers receive exhaust gas from an internal combustion engine and deliver compressed air to the internal combustion engine. Turbochargers increase the power output of the internal combustion engine, lower fuel consumption of the internal combustion engine, and/or reduce emissions produced by the internal combustion engine. Delivery of compressed air to the internal combustion engine by the turbocharger allows the internal combustion engine to be smaller, yet able to develop the same or similar amount of horsepower as larger, naturally aspirated internal combustion engines. Having a smaller internal combustion engine for use in a vehicle reduces the mass and aerodynamic frontal area of the vehicle, which helps reduce fuel consumption of the internal combustion engine and improve fuel economy of the vehicle.

Some turbochargers include a turbine having a divided volute turbine housing, with the turbochargers therefore sometimes alternatively referred to as a divided volute turbocharger, which includes dual volute turbochargers, twin scroll turbochargers, and the like. The volutes of a divided volute turbine housing are generally isolated from one another such that no mixing of exhaust gas occurs until after the exhaust gas passes a tongue or tongues of the respective volutes. The divided volute turbine housing includes a turbine inlet, a turbine outlet, and an interior volume. The turbine inlet is configured for attachment to an internal combustion engine (e.g., to an exhaust manifold or to a cylinder head of an internal combustion engine) and includes a plurality of inlet ports configured to be in fluid communication with exhaust paths of the internal combustion engine upon attachment. The interior volume of the turbine housing defines at least two divided volutes in fluid communication with the respective inlet ports for delivering exhaust gas from the internal combustion engine to a turbine wheel disposed in the interior volume. After energy is extracted from the exhaust gas by the turbine wheel, the exhaust gas exits the turbine housing via the turbine outlet. The volutes guide the exhaust gas from the exhaust manifold of the engine into an arcuate flow for distribution of exhaust around the circumference of the turbine wheel to rotate the turbine wheel.

Turbochargers also include a compressor. The compressor includes a compressor wheel coupled to the turbine wheel via a shaft. The compressor is powered by the rotation of the turbine wheel, which in turn drives a compressor wheel within a compressor housing of the compressor.

In multi-cylinder engines, cylinders fire in a specific order. For example, in an inline four-cylinder engine in which the cylinders are sequentially numbered 1 through 4, the firing order may be 1-3-4-2. A collection of cylinders may be grouped into a ‘bank.’ In the above example, a first bank of cylinders would include cylinders 1 and 4 and a second bank of cylinders would include cylinders 2 and 3. In the case of a “V” engine, the banks of cylinders can be separated across the engine, and multiple cylinders may be firing at the same time. In the case of an inline engine, the banks of cylinders could simply be the front cylinders versus the back cylinders, or an alternate collection of cylinders as described above. Exhaust gas flow is not a smooth stream because exhaust gases exit each cylinder based on the engine's firing sequence, resulting in intermittent exhaust gas pulses. The exhaust gas from each bank is conducted to the turbine housing in respective manifolds. The manifolds may be pipes and/or ducts attached to the internal combustion engine or may be integral to the internal combustion engine (e.g., manifold ducts cast into a cylinder head of the engine). By separating the exhaust gas streams, the “pulses” of pressure that occurs when the exhaust gas is released from the cylinder may be preserved through the volutes such that the pressure pulses impinge on the turbine wheel. The preservation of the pulses is typically desirable because the pressure pulse imparts momentum to the turbine wheel, thereby accelerating the turbine wheel faster and reducing turbo lag. Effective separation of the gas streams also reduces the instantaneous backpressure in the “non fired” volute. The term “fired” volute refers to the volute with the pressure pulse passing through it. This separation of pulse begins at the exhaust of each cylinder and is maintained in the exhaust manifold up to the turbine inlet (sometimes alternatively referred to as a turbine inlet scroll). In the region where the exhaust gases are admitted to the turbine housing, a separator wall between the respective volutes can help preserve the separation between exhaust gases from each cylinder or cylinder group, and thus maintain the pressure pulses. However, there often is still leakage of exhaust gas between respective volutes, which leads to reduced performance and efficiency of the turbocharger.

To aid in directing and controlling the exhaust flow from the volute or divided volutes to the turbine wheel uniformly, a vane ring (sometimes alternatively referred to as a nozzle ring or vaned nozzle stator) with a plurality of vanes can be disposed on an annular disk in the turbine housing interior between the volutes and turbine wheel. These vanes can be fixed to the annular disk (sometimes alternatively referred to as a fixed nozzle ring or fixed vaned nozzle stator) or can be rotatably coupled to the annular disk (sometimes alternatively referred to as a variable nozzle ring or variable vaned nozzle stator) to create a variable turbine geometry (VTG).

Typically, the rotatable vanes on the vane ring are equally spaced relative to each other and are each positioned at the same radial distance relative to the axis of rotation of the turbine wheel. Still further, such rotatable vanes are typically equally angled relative to a radial line drawn from the axis of rotation. Typically, the number of rotatable vanes disposed on the vane ring is an odd number, such as a prime number, which therein provides a degree of asymmetry along the vane ring associated with the odd number of equally spaced vanes.

As such, there remains a need to reduce leakage of exhaust gas from one of the volutes to the other of the volutes.

### SUMMARY OF THE INVENTION

An entryway system includes a divided volute turbocharger for receiving exhaust gas from an internal combustion engine and for delivering compressed air to the internal combustion engine. The internal combustion engine including a first set of cylinders and a second set of cylinders, with a relative pulse of the exhaust gas delivered from the first and second set of cylinders being generally equal for each exhaust stroke. The divided volute turbocharger includes a turbine housing including a turbine housing interior adapted to receive a turbine wheel having a plurality of turbine blades. The turbine housing extends along a turbine housing axis. The divided volute turbocharger also includes a first volute adapted for fluid communication with the internal combustion engine and the turbine housing interior for delivering exhaust gas from the first set of cylinders to the turbine housing interior, and a second volute adapted for fluid communication with the internal combustion engine and the turbine housing interior for delivering exhaust gas from the second set of cylinders to the turbine housing interior independently of the first volute. The divided volute turbocharger further includes a turbine housing outlet in fluid communication with the turbine housing interior, and a wall separating the first volute from the second volute. The wall has a first wall surface facing the turbine housing axis. The entryway system includes a vane ring coupled to the turbine housing and disposed in the turbine housing interior between the first and second volutes and around the turbine wheel. The vane ring includes a vane divider wall further separating the first volute from the second volute. The vane divider wall has a vane divider surface facing the first wall surface. The vane ring includes a plurality of vanes coupled to the vane divider wall. The first wall surface of the wall and the vane divider surface of the vane divider wall define a restriction path between one another with respect to the turbine housing axis. At least a portion of the restriction path is non-parallel to the turbine housing axis such that leakage of exhaust gas from one of the first and second volutes to the other of the first and second volutes is reduced.

In another embodiment, an entryway system includes a divided volute turbocharger for receiving exhaust gas from an internal combustion engine and for delivering compressed air to the internal combustion engine. The internal combustion engine including a first set of cylinders and a second set of cylinders, with a relative pulse of the exhaust gas delivered from the first and second set of cylinders being generally equal for each exhaust stroke. The divided volute turbocharger includes a turbine housing including a turbine housing interior adapted to receive a turbine wheel having a plurality of turbine blades. The turbine housing extends along a turbine housing axis. The divided volute turbocharger also includes a first volute adapted for fluid communication with the internal combustion engine and the turbine housing interior for delivering exhaust gas from the first set of cylinders to the turbine housing interior, and a second volute adapted for fluid communication with the internal combustion engine and the turbine housing interior for delivering exhaust gas from the second set of cylinders to the turbine housing interior independently of the first volute. The divided volute turbocharger further includes a turbine housing outlet in fluid communication with the turbine housing interior, and a wall separating the first volute from the second volute. The wall has a first wall surface facing the turbine housing axis. The entryway system includes a vane ring coupled to the turbine housing and disposed in the turbine housing interior between the first and second volutes and around the turbine wheel. The vane ring includes a vane divider wall further separating the first volute from the second volute. The vane divider wall has a vane divider surface facing the first wall surface. The vane ring includes a plurality of vanes coupled to the vane divider wall, with the plurality of vanes being fixed to the vane divider wall. The entryway system also includes a pin coupled to the vane ring and the turbine housing for preventing rotation of the vane ring with respect to the turbine housing.

In another embodiment, an entryway system includes a divided volute turbocharger for receiving exhaust gas from an internal combustion engine and for delivering compressed air to the internal combustion engine. The internal combustion engine including a first set of cylinders and a second set of cylinders, with a relative pulse of the exhaust gas delivered from the first and second set of cylinders being generally equal for each exhaust stroke. The divided volute turbocharger includes a turbine housing including a turbine housing interior adapted to receive a turbine wheel having a plurality of turbine blades. The turbine housing extends along a turbine housing axis. The divided volute turbocharger also includes a first volute adapted for fluid communication with the internal combustion engine and the turbine housing interior for delivering exhaust gas from the first set of cylinders to the turbine housing interior, and a second volute adapted for fluid communication with the internal combustion engine and the turbine housing interior for delivering exhaust gas from the second set of cylinders to the turbine housing interior independently of the first volute. The divided volute turbocharger further includes a turbine housing outlet in fluid communication with the turbine housing interior, and a wall separating the first volute from the second volute. The wall has a first wall surface facing the turbine housing axis. The entryway system includes a vane ring coupled to the turbine housing and disposed in the turbine housing interior between the first and second volutes and around the turbine wheel. The vane ring includes a vane divider wall further separating the first volute from the second volute. The vane divider wall has a vane divider surface facing the first wall surface. The vane ring includes a plurality of vanes coupled to the vane divider wall. The entryway system further includes a pin coupled to the vane ring and the turbine housing for preventing rotation of the vane ring with respect to the turbine housing. The wall includes a tongue, with the tongue presenting the first wall surface. The pin is adjacent the first wall surface such that the pin is configured to be a leading edge of one of the vanes.

### BRIEF DESCRIPTION OF THE DRAWINGS

Other advantages of the present disclosure will be readily appreciated, as the same becomes better understood by reference to the following detailed description when considered in connection with the accompanying drawings.

FIG. 1 is a side cross-sectional view of an entryway system including a divided volute turbocharger, with the divided volute turbocharger including a turbine housing adapted to receive a turbine wheel with the turbine housing extending along a turbine housing axis, and with the divided volute turbocharger also including a first volute, a second volute, a turbine housing outlet, and a wall, and with the entryway system further including a vane ring coupled to the turbine housing and disposed in the turbine housing interior.

FIG. 2 is a side cross-sectional view of the entryway system, with the wall having a first wall surface facing the turbine housing axis, with the vane ring including a vane divider wall having a vane divider surface facing the first wall surface, with the first wall surface and the vane divider surface defining a restriction path between one another with respect to the turbine housing axis, and with at least a portion of the restriction path being non-parallel to the turbine housing axis such that leakage of exhaust gas from one of the first and second volutes to the other of the first and second volutes is reduced.

FIG. 3 is a top view of the entryway system, with the entryway system including a pin coupled to the vane ring and the turbine housing for preventing rotation of the vane ring with respect to the turbine housing, with the wall of the turbine housing having a tongue, with a vane of the plurality of vanes having a leading edge, and with the pin being adjacent the first wall surface such that the pin is configured to be a leading edge of one of the vanes.

FIG. 4 is a side cross-sectional view of the entryway system, with the turbine housing defining a turbine housing slot, with the vane divider wall defining a divider slot, and with the pin being disposed in the turbine housing slot and the divider slot.

FIG. 5 is a side cross-sectional view of the entryway system, with the outer circumferential ring defining an outer ring slot, and with the pin being disposed in the outer ring slot and the turbine housing slot.

FIG. 6 is a close-up side cross-sectional view of the entryway system of FIG. 5.

FIG. 7 is a side cross-sectional view of the entryway system, with the pin being further defined as a first pin, and further including a second pin, with the first pin being coupled to the vane divider wall and the turbine housing, with the second pin coupled to the outer circumferential ring and the turbine housing, with the first pin being disposed in the divider slot and a first turbine housing slot, and with the second pin being disposed in a second turbine housing slot and the outer vane ring slot.

FIG. 8 is an exploded view of the entryway system, with the vane ring and the outer circumferential ring being separate components, and with the entryway system further including a spring.

FIG. 9 is a side cross-sectional view of the entryway system, with the spring coupled to the vane ring for preloading the vane ring against the turbine housing to reduce vibrations during operation of the divided volute turbocharger.

FIG. 10 is a perspective view of the entryway system, with the turbine housing having a first turbine housing surface facing a first direction, with the outer circumferential ring having a second surface facing a second direction opposite the first direction, and with the first turbine housing surface and the second turbine surface being angled with respect to the turbine housing axis.

### DETAILED DESCRIPTION OF THE INVENTION

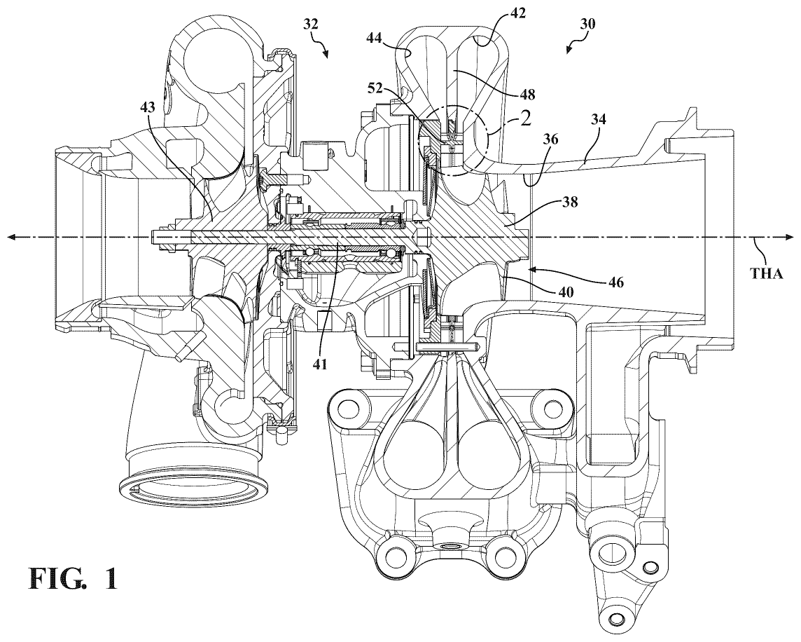

With reference to the Figures, wherein like numerals indicate like parts throughout the several views, an entryway system 30 is generally shown in FIG. 1. The entryway system 30 includes a divided volute turbocharger 32 for receiving exhaust gas from an internal combustion engine and for delivering compressed air to the internal combustion engine. The internal combustion engine includes a first set of cylinders and a second set of cylinders, with a relative pulse of the exhaust gas delivered from the first and second set of cylinders being generally equal for each exhaust stroke.

With continued reference to FIG. 1, the divided volute turbocharger 32 includes a turbine housing 34 including a turbine housing interior 36 adapted to receive a turbine wheel 38 having a plurality of turbine blades 40. The turbine housing 34 extends along a turbine housing axis THA.

The divided volute turbocharger 32 may include a turbocharger shaft 41 rotatably coupled to the turbine wheel 38 and may include a compressor wheel 43 rotatably coupled to the turbocharger shaft 41. The divided volute turbocharger 32 also includes a first volute 42 adapted for fluid communication with the internal combustion engine and the turbine housing interior 36 for delivering exhaust gas from the first set of cylinders to the turbine housing interior 36, and a second volute 44 adapted for fluid communication with the internal combustion engine and the turbine housing interior 36 for delivering exhaust gas from the second set of cylinders to the turbine housing interior 36 independently of the first volute 42.

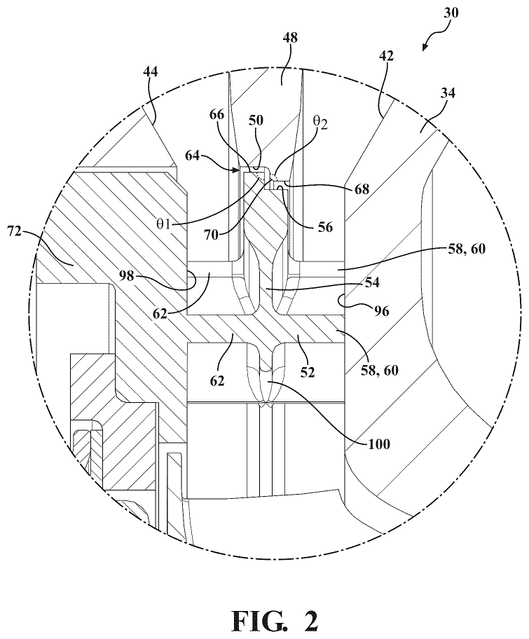

The divided volute turbocharger 32 further includes a turbine housing outlet 46 in fluid communication with the turbine housing interior 36, and a wall 48 separating the first volute 42 from the second volute 44. With reference to FIG. 2, the wall 48 has a first wall surface facing the turbine housing axis THA.

With continued reference to FIG. 2, the entryway system 30 also includes a vane ring 52 coupled to the turbine housing 34 and disposed in the turbine housing interior 36 between the first and second volutes 42, 44 and around the turbine wheel 38. The vane ring 52 includes a vane divider wall 54 further separating the first volute 42 from the second volute 44. In other words, the vane divider wall 54 is operably aligned with the wall 48 of the turbine housing 34 to further extend the wall 48 of the turbine housing 34 toward the turbine wheel 38 to further separate the first volute 42 from the second volute 44. The vane divider wall 54 has a vane divider surface 56 facing the first wall surface 50, and the vane ring 52 includes a plurality of vanes 58 coupled to the vane divider wall 54. Although not required, the plurality of vanes 58 may be further defined as a first plurality of vanes 60 protruding from the vane divider wall 54 and into the first volute 42, and a second plurality of vanes 62 protruding from the vane divider wall 54 and into the second volute 44. Typically, the plurality of vanes 58 is fixed to the vane divider wall 54. In other words, each vane of the plurality of vanes 58 are immovable with respect to the vane divider wall 54. In such embodiments, the vane ring 52 may be referred to as a fixed vane ring. Depending on the application of the entryway system 30, the vane ring 52 may be optimized, such as adjusting various dimensions of the vane ring 52 and/or the angle of the plurality of vanes 58. As mentioned above, the entryway system 30 having the vane ring 52 increases efficiency of the entryway system 30/divided volute turbocharger 32, such as increasing efficiency by 1-3%.

The first wall surface 50 of the wall 48 and the vane divider surface 56 of the vane divider wall 54 define a restriction path 64 between one another with respect to the turbine housing axis THA. At least a portion of the restriction path 64 is non-parallel to the turbine housing axis THA such that leakage of exhaust gas from one of the first and second volutes 42, 44 to the other of the first and second volutes 42, 44 is reduced. It is to be appreciated that the restriction path 64 includes embodiments where the first wall surface 50 and the vane divider surface 56 are engaged with one another, and where the first wall surface 50 and the vane divider surface are spaced from one another such as to accommodate for thermal deformation of the turbine housing 34. In either of these two embodiments, leakage of exhaust gas between the first volute 42 and the second volute 44 is reduced. When leakage of exhaust gas between the first volute 42 and second volute 44 are reduced, the inflow of exhaust gas to the turbine wheel 38 is improved which promotes better performance and efficiency of the divided volute turbocharger 32. Improving performance and efficiency of the divided volute turbocharger 32 also improves fuel economy (which allows vehicle manufacturers to meet current and future emissions regulation requirements) and brake thermal of the internal combustion engine, and improves durability of the entryway system 30.

It is to be appreciated that throughout the disclosure that references of the turbine housing axis THA may also include relation of various components to other axes, such as a vane ring axis, turbocharger shaft axis, rotor axis, etc. For example, the first wall surface 50 of the wall 48 and the vane divider surface 56 of the vane divider wall 54 may define the restriction path 64 between one another with respect to the vane ring axis. As a further example, the first wall surface 50 of the wall 48 and the vane divider surface 56 of the vane divider wall 54 may define the restriction path 64 between one another with respect to the turbocharger shaft axis. As a further example, the first wall surface 50 of the wall 48 and the vane divider surface 56 of the vane divider wall 54 may define the restriction path 64 between one another with respect to a rotor axis. The turbine housing axis THA, vane ring axis, turbocharger shaft axis, and a rotor axis may be concentric with one another. Alternatively, the turbine housing axis, vane ring axis, turbocharger shaft axis, and rotor axis may not be concentric with one another, or some of the axes may be concentric with one another while other axes are not concentric with one another. It is to be appreciated that it is contemplated that all other references of the turbine housing axis THA throughout the disclosure may equally apply to other axes of the entryway system 30, such as the vane ring axis, turbocharger shaft axis, rotor axis, and the like.

The restriction path 64 may be any path defined between the vane divider surface 56 and the first wall surface 50 that has at least a portion of the path that is non-parallel with respect to the turbine housing axis THA. For example, the restriction path 64 may have a tortuous configuration with respect to the turbine housing axis THA. As a further example, the restriction path 64 may have a meandering configuration with respect to the turbine housing axis THA. As a further example, the restriction path 64 may have a curved configuration with respect to the turbine housing axis THA. As a further example, the restriction path 64 may be angled with respect to the turbine housing axis THA. As a further example, the restriction path 64 may have a stepped configuration.

As a further example, as shown in FIG. 2, the restriction path 64 may have a first restriction path 66 adjacent the first volute 42 and extending parallel with respect to the turbine housing axis THA, a second restriction path 68 adjacent the second volute 44 and extending parallel with respect to the turbine housing axis THA, and a third restriction path 70 extending from the first restriction path 66 to the second restriction path 68. In such embodiments, the third restriction path 70 may define a first angle Θ1 with the first restriction path 66 and may define a second angle Θ2 with the second restriction path 68. The first and second angles Θ1, Θ2 may be acute with respect to the turbine housing axis THA. When the first and second angles Θ1, Θ2 are acute with respect to the turbine housing axis THA, the first angle Θ1 may be between 45-90 degrees and the second angle Θ2 may be between 45-90 degrees. Alternatively, the first and second angles Θ1, Θ2 may be obtuse with respect to the turbine housing axis THA. When the first and second angles Θ1, Θ2 are obtuse with respect to the turbine housing axis THA, the first angle Θ1 may be between 90-135 degrees and the second angle Θ2 may be between 90-135 degrees. As a further example, the third restriction path 70 may be orthogonal with respect to at least one of the turbine housing axis THA and the first and second restriction paths 66, 68. The restriction path 64 may have a Z-configuration with respect to the turbine housing axis THA. In embodiments where the restriction path 64 has a Z-configuration, the restriction path 64 may have the first restriction path 66, the second restriction path 68, and the third restriction path 70, with the first, second, and third restriction paths 66, 68, 70 defining the Z-configuration.

Having at least a portion of the restriction path 64 being non-parallel to the turbine housing axis THA reduces leakage of exhaust gas from one of the first and second volutes 42, 44 to the other of the first and second volutes 42, 44 is reduced. Although not required and although not explicitly shown in the FIGS., to further reduce leakage of exhaust gas from one of the first and second volutes 42, 44 to the other of the first and second volutes 42, 44, an abradable coating may be disposed on at least one of the first wall surface 50 and the vane divider surface 56. Alternatively, a seal may be disposed between the first wall surface 50 and the vane divider surface 56. Alternatively, a metallic foam may be disposed between the first wall surface 50 and the vane divider surface 56. Alternatively, a para-aramid synthetic fiber, such as Kevlar®, may be disposed between the first wall surface 50 and the vane divider surface 56.

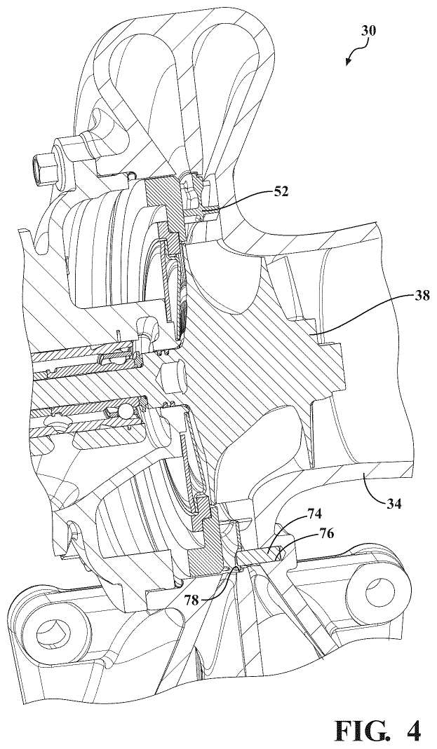

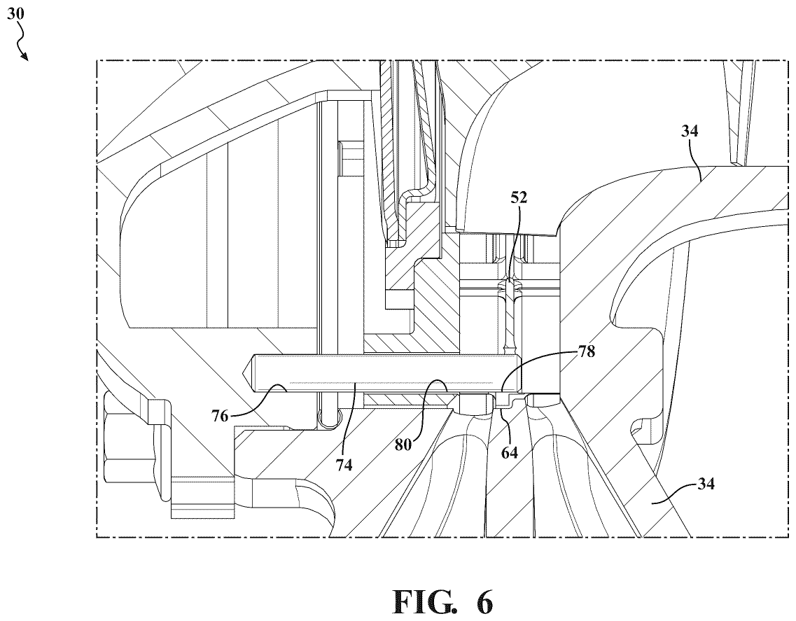

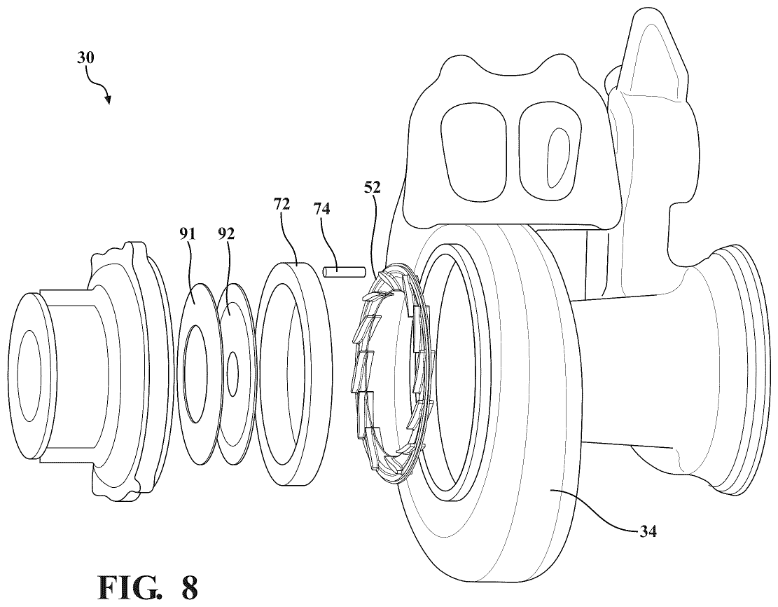

The first plurality of vanes 60, the second plurality of vanes 62, and the vane divider wall 54 may be integral with one another, as shown in FIGS. 1, 2, 4-7, and 9. As shown in FIGS. 1-9, the vane ring 52 may include an outer circumferential ring 72 coupled to the divider wall 48. It is to be appreciated that the outer circumferential ring 72 may be further referred to as a backplate. The plurality of vanes 58, which may include the first plurality of vanes 60 and the second plurality of vanes 62, the vane divider wall 54, and the outer circumferential ring 72 may be integral (i.e., one piece) with one another. Alternatively, the outer circumferential ring 72 and the vane ring 52 may be separate components from one another, as shown in FIG. 8.

With reference to FIGS. 1 and 3-8, the entryway system 30 may further include a pin 74 coupled to the vane ring 52 and the turbine housing 34 for preventing rotation of the vane ring 52 with respect to the turbine housing 34. Circumferential force from exhaust on the plurality of vanes 58 as well as thermal deformation of the turbine housing 34 can lead to rotation and wear of the vane ring 52 and other components of the entryway system 30; however, the entryway system 30 including the pin 74 coupled to the vane ring 52 and the turbine housing 34 prevents rotation of the vane ring 52 with respect to the turbine housing 34 and, therefore, reduces wear on the vane ring 52 when compared to entryway systems that allow rotation of the vane ring with respect to the turbine housing.

In one embodiment, as shown in FIGS. 1 and 3-7, the pin 74 is coupled to the vane divider wall 54. In another embodiment, the pin 74 is coupled to at least one of the vane divider wall 54 and the outer circumferential ring 72 of the vane ring 52 and the turbine housing 34 for preventing rotation of the vane ring 52 with respect to the turbine housing 34. The pin 74 may extend parallel with respect to the turbine housing axis THA, or the pin 74 may alternatively extend perpendicular with respect to the turbine housing axis THA.

To secure the pin 74, the turbine housing 34 may define a turbine housing slot 76, with the pin 74 being disposed in the turbine housing slot 76. Alternatively, or additionally, the vane divider wall 54 may define a divider slot 78, with the pin 74 being disposed in the divider slot 78.

In embodiments where the vane ring 52 includes the outer circumferential ring 72, the outer circumferential ring 72 may define an outer ring slot 80, with the pin 74 being disposed in the outer ring slot 80.

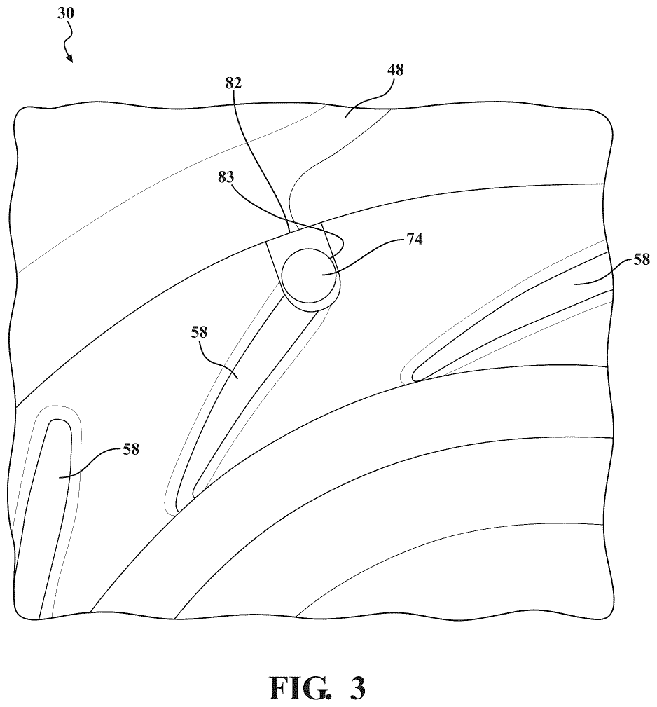

With reference to FIG. 3, the wall 48 may include a tongue 82, with the tongue 82 presenting the first wall surface 50. In such embodiments, the pin 74 may be adjacent the first wall surface 50 such that the pin 74 is configured to be a leading edge 83 of one of the vanes of the plurality of vanes 58. Having the pin 74 configured to be the leading edge 83 of one of the vanes of the plurality of vanes 58 allows the pin 74 to direct exhaust flow through. The pin 74 may be configured advantageously for directing the flow of exhaust gas through the plurality of vanes 58, such as the leading edge being curved, angled, or otherwise configured to direct the flow of exhaust gas through the plurality of vanes 58. Additionally, the leading edge 83 of the pin 74 may be located under the tongue 82, which mitigates or even eliminates disruption of the flow of exhaust gas and/or any side-to-side leakage occurring around the pin when exhaust gas flows through the vane ring 52 due to being in the wake of the tongue 82.

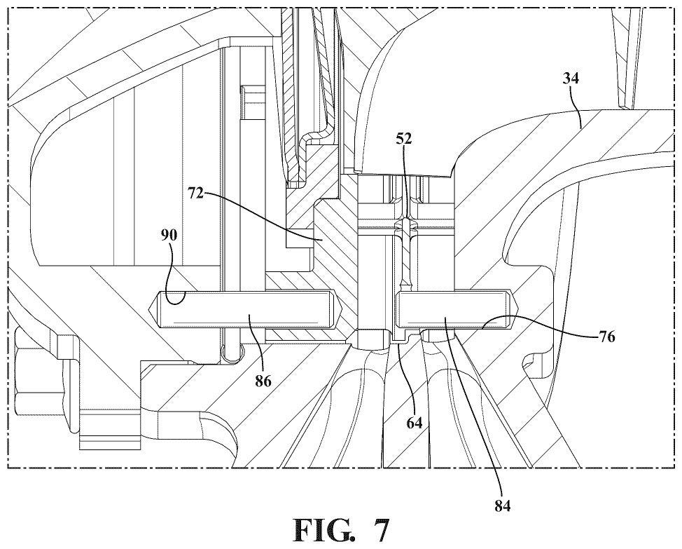

It is to be appreciated that the pin 74 may be further defined as a first pin 84 and that the entryway system 30 may include a second pin 86. In such embodiments, the first pin 84 may be coupled to the vane divider wall 54 and the turbine housing 34, and the second pin 86 may be coupled to the outer circumferential ring 72 and the turbine housing 34. The first pin 84 may be disposed in the divider slot 78 and the turbine housing slot 76, as shown in FIG. 7. The outer circumferential ring 72 may define an outer vane ring slot 88 and the turbine housing 34 may define a second turbine housing slot 90, with the second pin 86 being disposed in the outer vane ring slot 88 and the second turbine housing slot 90.

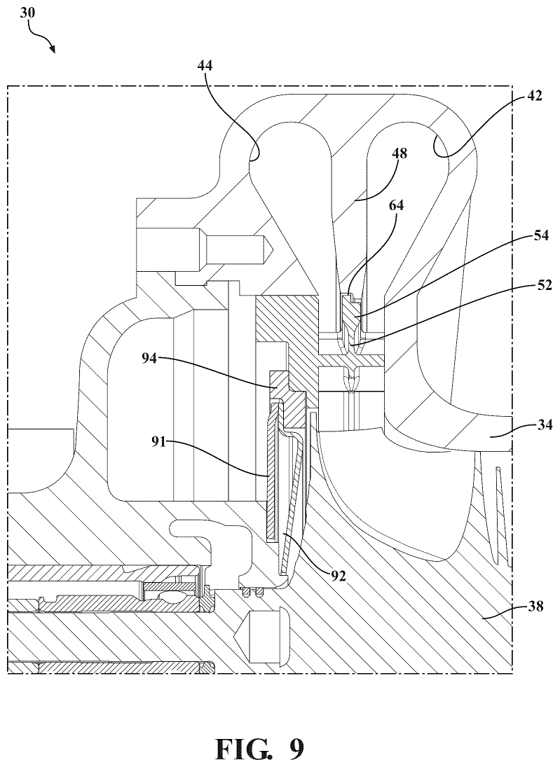

As shown in FIGS. 8 and 9, the entryway system 30 may include a spring 91 coupled to the vane ring 52 for preloading the vane ring 52 against the turbine housing 34 to reduce vibrations during operation of the divided volute turbocharger 32 and to also reduce any end face leakage of the vane ring 52. In one embodiment, the spring 91 may be further defined as one of a cup spring, wave spring, coil spring, clover spring, Belville washer spring, and the like. The spring 91 also may preload the vane ring 52 during installation of the vane ring 52. The entryway system 30 may include a heat shield 92 coupled to and disposed between the vane ring 52 and the spring 91 with respect to the turbine housing axis THA. The entryway system 30 may include an adapter 94 coupled to and disposed between the heat shield 92 and the vane ring 52.

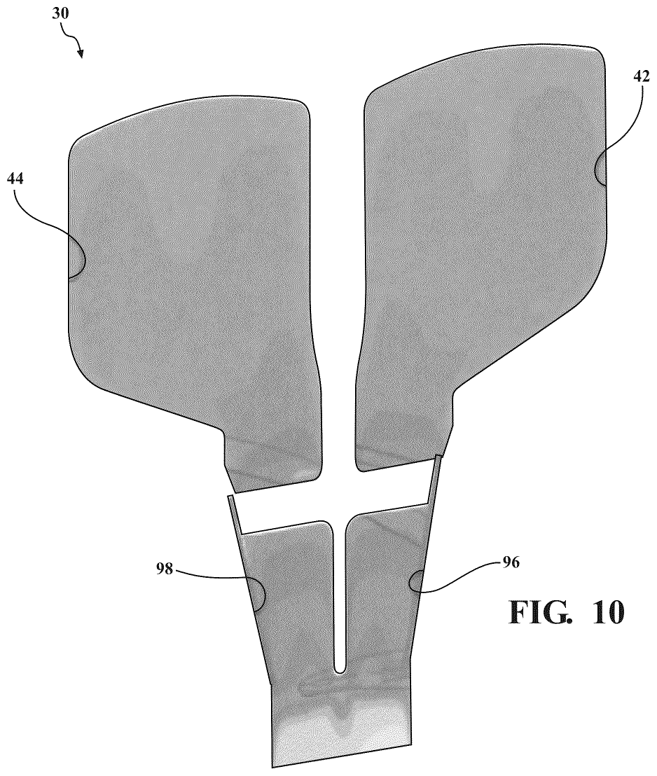

With reference to FIGS. 2 and 10, the turbine housing 34 may have a first turbine housing surface 96 engaged with the vane ring 52 and facing a first direction with respect to the turbine housing axis THA, and the outer circumferential ring 72 may have a second surface 98 facing a second direction opposite the first direction with respect to the turbine housing axis THA. At least one of the first turbine housing surface 96 and the second surface 98 of the outer circumferential ring 72 are angled with respect to the turbine housing axis THA. In one embodiment, the first turbine housing surface 96 is angled with respect to the turbine housing axis THA and additionally or alternatively, the second surface 98 of the outer circumferential ring 72 is angled with respect to the turbine housing axis THA. Having the second surface 98 and the first turbine housing surface being angled with respect to the turbine housing axis THA produces a conical configuration, which can help with alignment and preloading of the vane ring 52 during assembly of the entryway system 30.

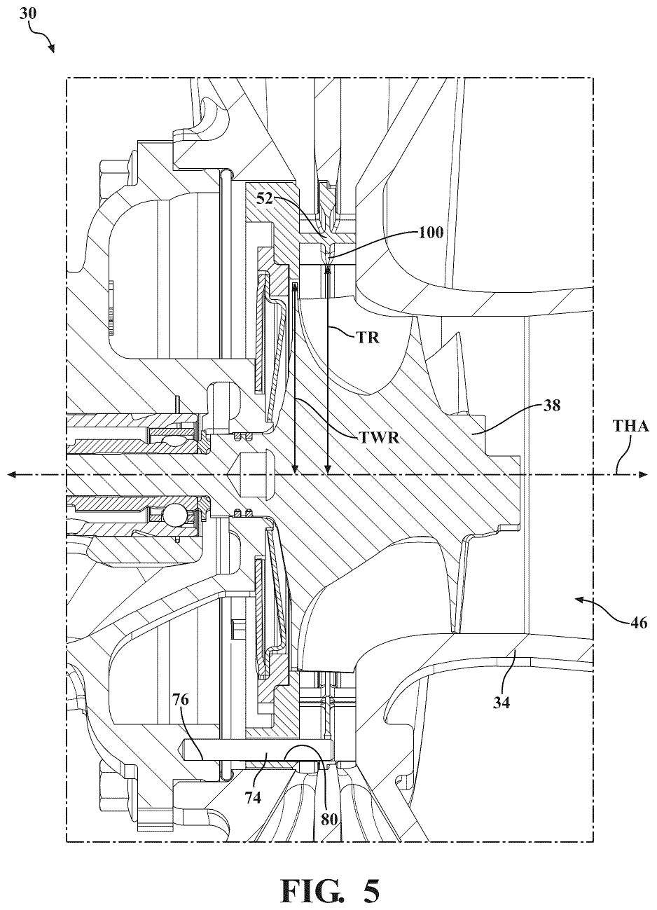

With reference to FIGS. 2 and 5, the vane divider wall 54 may have an inner divider wall tip 100 extending toward the turbine wheel 38, and the inner divider wall tup 100 may be chamfered. The inner divider wall tup 100 may have a tip radius TR defined therebetween with the turbine housing axis THA and the turbine wheel 38 may have a turbine wheel radius TWR, with the tip radius TR optionally being 1.05-1.25 times greater than the turbine wheel radius TWR, or 1.15-1.25 time greater.

It is to be appreciated the divided volute turbocharger 32 may be further defined as a twin scroll turbocharger (oftentimes referred to as a twin volute turbocharger, wherein the first and second volutes are parallel about 360 degrees of the turbine wheel inlet), a dual volute turbocharger, and the like.

In another embodiment, the entryway system 30 includes the divided volute turbocharger 32 for receiving exhaust gas from an internal combustion engine and for delivering compressed air to the internal combustion engine. The internal combustion engine includes a first set of cylinders and a second set of cylinders, with a relative pulse of the exhaust gas delivered from the first and second set of cylinders being generally equal for each exhaust stroke. The divided volute turbocharger 32 includes the turbine housing 34 including the turbine housing interior 36 adapted to receive the turbine wheel 38 having the plurality of turbine blades 40. The turbine housing 34 extends along the turbine housing axis THA. The divided volute turbocharger 32 also includes the first volute 42 adapted for fluid communication with the internal combustion engine and the turbine housing interior 36 for delivering exhaust gas from the first set of cylinders to the turbine housing interior 36, and the second volute 44 adapted for fluid communication with the internal combustion engine and the turbine housing interior 36 for delivering exhaust gas from the second set of cylinders to the turbine housing interior 36 independently of the first volute 42. The divided volute turbocharger 32 further includes the turbine housing outlet 46 in fluid communication with the turbine housing interior 36, and the wall 48 separating the first volute 42 from the second volute 44. With reference to FIG. 2, the wall 48 has a first wall surface facing the turbine housing axis THA. With continued reference to FIG. 2, the entryway system 30 also includes the vane ring 52 coupled to the turbine housing 34 and disposed in the turbine housing interior 36 between the first and second volutes 42, 44 and around the turbine wheel 38. The vane ring 52 includes the vane divider wall 54 further separating the first volute 42 from the second volute 44. The vane divider wall 54 has the vane divider surface 56 facing the first wall surface 50, and the vane ring 52 includes the plurality of vanes 58 coupled to the vane divider wall 54. The entryway system 30 further includes a pin coupled to the vane ring 52 and the turbine housing 34 for preventing rotation of the vane ring 52 with respect to the turbine housing 34. The wall 48 includes the tongue 82, with the tongue 82 presenting the first wall surface 50. The pin 74 is adjacent the first wall surface 50 such that the pin 74 is configured to be the leading edge 83 of one of the vanes of the plurality of vanes 58. Having the pin 74 configured to be the leading edge 83 of one of the vanes of the plurality of vane 58 allows the pin 74 to direct exhaust flow through. The pin 74 may be configured advantageously for directing the flow of exhaust gas through the plurality of vanes 58, such as the leading edge being curved, angled, or otherwise configured to direct the flow of exhaust gas through the plurality of vanes 58. Additionally, the leading edge 83 of the pin 74 may be located under the tongue 82, which mitigates or even eliminates disruption of the flow of exhaust gas and/or any side-to-side leakage occurring around the pin when exhaust gas flows through the vane ring 52 due to being in the wake of the tongue 82.

Although the present invention has been described above, it is to be appreciated that the invention may also be defined in accordance with the following embodiments:
Embodiment 1: An entryway system comprising:
   a divided volute turbocharger for receiving exhaust gas from an internal combustion engine and for delivering compressed air to the internal combustion engine, the internal combustion engine including a first set of cylinders and a second set of cylinders, with a relative pulse of the exhaust gas delivered from the first and second set of cylinders being generally equal for each exhaust stroke, said divided volute turbocharger comprising:
      a turbine housing comprising a turbine housing interior adapted to receive a turbine wheel having a plurality of turbine blades, with said turbine housing extending along a turbine housing axis,
      a first volute adapted for fluid communication with the internal combustion engine and said turbine housing interior for delivering exhaust gas from the first set of cylinders to said turbine housing interior,
      a second volute adapted for fluid communication with the internal combustion engine and said turbine housing interior for delivering exhaust gas from the second set of cylinders to said turbine housing interior independently of said first volute,
      a turbine housing outlet in fluid communication with said turbine housing interior, and
      a wall separating said first volute from said second volute, wherein said wall has a first wall surface facing said turbine housing axis; and
   a vane ring coupled to said turbine housing and disposed in said turbine housing interior between said first and second volutes and around said turbine wheel, wherein said vane ring comprises a vane divider wall further separating said first volute from said second volute, wherein said vane divider wall has a vane divider surface facing said first wall surface, and wherein said vane ring comprises a plurality of vanes coupled to said vane divider wall;
   wherein said first wall surface of said wall and said vane divider surface of said vane divider wall define a restriction path between one another with respect to said turbine housing axis, and wherein at least a portion of said restriction path is non-parallel to said turbine housing axis such that leakage of exhaust gas from one of said first and second volutes to the other of said first and second volutes is reduced.
Embodiment 2: The entryway system as set forth in embodiment 1, wherein said restriction path has a tortuous configuration with respect to said turbine housing axis.
Embodiment 3: The entryway system as set forth in any one of the preceding embodiments, wherein said restriction path has a curved configuration with respect to said turbine housing axis.
Embodiment 4: The entryway system as set forth in any one of the preceding embodiments, wherein said restriction path defined between said vane divider surface and said first wall surface of said wall has a first restriction path adjacent said first volute and extending parallel with respect to said turbine housing axis, a second restriction path adjacent said second volute and extending parallel with respect to said turbine housing axis, and a third restriction path extending from said first restriction path to said second restriction path.
Embodiment 5: The entryway system as set forth in embodiment 4, wherein said third restriction path defines a first angle with said first restriction path and defines a second angle with said second restriction path, and wherein said first and second angles are acute with respect to said turbine housing axis.
Embodiment 6: The entryway system as set forth in embodiment 5, wherein said first angle is between 45-90 degrees and said second angle is between 45-90 degrees.
Embodiment 7: The entryway system as set forth in embodiment 4, wherein said third restriction path defines a first angle with said first restriction path and defines a second angle with said second restriction path, and wherein said first and second angles are obtuse with respect to said turbine housing axis.
Embodiment 8: The entryway system as set forth in embodiment 7, wherein said first angle is between 90-135 degrees and said second angle is between 90-135 degrees.
Embodiment 9: The entryway system as set forth in embodiment 4, wherein said third restriction path is orthogonal with respect to at least one of said turbine housing axis and said first and second restriction paths.
Embodiment 10: The entryway system as set forth in embodiment 1, wherein said restriction path is angled with respect to said turbine housing axis.
Embodiment 11: The entryway system as set forth in any one of the preceding embodiments, wherein said restriction path has a Z configuration with respect to said turbine housing axis.
Embodiment 12: The entryway system as set forth in any one of the preceding embodiments, wherein said restriction path is defined 360 degrees about said turbine housing axis.
Embodiment 13: The entryway system as set forth in any one of the preceding embodiments, wherein an abradable coating is disposed on at least one of said first wall surface and said vane divider surface.
Embodiment 14: The entryway system as set forth in any one of embodiments 1-12, wherein a seal is disposed between said first wall surface and said vane divider surface.
Embodiment 15: The entryway system as set forth in any one of embodiments 1-12, wherein a metallic foam is disposed between said first wall surface and said vane divider surface.
Embodiment 16: The entryway system as set forth in any one of embodiments 1-12, wherein a para-aramid synthetic fiber is disposed between said first wall surface and said vane divider surface.
Embodiment 17: The entryway system as set forth in any one of the preceding embodiments, wherein said vane ring further comprises an outer circumferential ring coupled to said vane divider wall.
Embodiment 18: The entryway system as set forth in any one of the preceding embodiments, wherein said plurality of vanes are further defined as a first plurality of vanes protruding from said vane divider wall and into said first volute, and a second plurality of vanes protruding from said vane divider wall and into said second volute.
Embodiment 19: The entryway system as set forth in embodiment 18, wherein said first plurality of vanes, said second plurality of vanes, and said vane divider wall are integral with one another.
Embodiment 20: The entryway system as set forth in any one of embodiments 17-19, wherein said plurality of vanes, said vane divider wall, and said outer circumferential ring are integral with one another.
Embodiment 21: The entryway system as set forth in any one of the preceding embodiments further comprising a pin coupled to said vane ring and said turbine housing for preventing rotation of said vane ring with respect to said turbine housing.
Embodiment 22: The entryway system as set forth in embodiment 21, wherein said pin is coupled to said vane divider wall.
Embodiment 23: The entryway system as set forth in any one of embodiments 21 and 22, wherein said pin is coupled to at least one of said vane divider wall and said outer circumferential ring of said vane ring and said turbine housing for preventing rotation of said vane ring with respect to said turbine housing.
Embodiment 24: The entryway system as set forth in any one of embodiments 21-23, wherein said pin extends parallel with respect to said turbine housing axis.
Embodiment 25: The entryway system as set forth in embodiment 21-23, wherein said pin extends perpendicular with respect to said turbine housing axis.
Embodiment 26: The entryway system as set forth in any one of embodiments 21-25, wherein said turbine housing defines a turbine housing slot, and wherein said pin is disposed in said turbine housing slot.
Embodiment 27: The entryway system as set forth in any one of embodiments 21-26, wherein said vane divider wall defines a divider slot, and wherein said pin is disposed in said divider slot.
Embodiment 28: The entryway system as set forth in any one of embodiments 21-27, wherein said outer circumferential ring defines an outer ring slot, and wherein said pin is disposed in said outer ring slot.
Embodiment 29: The entryway system as set forth in any one of the preceding embodiments, wherein said wall comprises a tongue, with said tongue presenting said first wall surface, and wherein said pin is adjacent said first wall surface such that said pin is configured to be a leading edge of one of said vanes.
Embodiment 30: The entryway system as set forth in embodiment 21, wherein said pin is further defined as a first pin, and further comprising a second pin, wherein said first pin is coupled to said vane divider wall and said turbine housing, and wherein said second pin is coupled to said outer circumferential ring and said turbine housing.
Embodiment 31: The entryway system as set forth in embodiment 30, wherein said vane divider wall defines a divider slot and said turbine housing defines a first turbine housing slot, and wherein said first pin is disposed in said divider slot and said first turbine housing slot.
Embodiment 32: The entryway system as set forth in embodiment 31, wherein said outer circumferential ring defines an outer vane ring slot and said turbine housing defines a second turbine housing slot, and wherein said second pin is disposed in said outer vane ring slot and said second turbine housing slot.
Embodiment 33: The entryway system as set forth in any one of the preceding embodiments further comprising a spring coupled to said vane ring for preloading said vane ring against said turbine housing to reduce vibrations during operation of said divided volute turbocharger.
Embodiment 34: The entryway system as set forth in embodiment 33, wherein said spring is further defined as one of a cup spring, wave spring, coil spring, clover spring, and Belville washer spring.
Embodiment 35: The entryway system as set forth in any one of embodiments 33 and 34 further comprising a heat shield coupled to and disposed between said vane ring and said spring with respect to said turbine housing axis.
Embodiment 36: The entryway system as set forth in any one of the preceding embodiments, wherein said turbine housing has a first turbine housing surface engaged with said vane ring and facing a first direction with respect to said turbine housing axis, wherein said outer circumferential ring has a second surface facing a second direction opposite said first direction with respect to said turbine housing axis, and wherein at least one of said first turbine housing surface and said second surface of said outer circumferential ring are angled with respect to said turbine housing axis.
Embodiment 37: The entryway system as set forth in embodiment 36, wherein said first turbine housing surface is angled with respect to said turbine housing axis.
Embodiment 38: The entryway system as set forth in any one of embodiments 36 and 37, wherein said second surface of said outer circumferential ring is angled with respect to said turbine housing axis.
Embodiment 39: The entryway system as set forth in any one of the preceding embodiments, wherein said vane divider wall has an inner divider wall tip extending toward said turbine wheel, and wherein said inner divider wall tip is chamfered.
Embodiment 40: The entryway system as set forth in embodiment 39, wherein said inner divider wall tip has a tip radius defined therebetween with said turbine housing axis, wherein said turbine wheel has a turbine wheel radius, and wherein said tip radius is 1.05-1.25 times greater than said turbine wheel radius.
Embodiment 41: The entryway system as set forth in any one of the preceding embodiments, wherein said plurality of vanes are fixed to said vane divider wall.
Embodiment 42: The entryway system as set forth in any one of the preceding embodiments, wherein said divided volute turbocharger is further defined as a twin volute turbocharger.
Embodiment 43: An entryway system comprising:
   a divided volute turbocharger for receiving exhaust gas from an internal combustion engine and for delivering compressed air to the internal combustion engine, the internal combustion engine including a first set of cylinders and a second set of cylinders, with a relative pulse of the exhaust gas delivered from the first and second set of cylinders being generally equal for each exhaust stroke, said divided volute turbocharger comprising:
      a turbine housing comprising a turbine housing interior adapted to receive a turbine wheel having a plurality of turbine blades, with said turbine housing extending along a turbine housing axis,
      a first volute adapted for fluid communication with the internal combustion engine and said turbine housing interior for delivering exhaust gas from the first set of cylinders to said turbine housing interior,
      a second volute adapted for fluid communication with the internal combustion engine and said turbine housing interior for delivering exhaust gas from the second set of cylinders to said turbine housing interior independently of said first volute,
      a turbine housing outlet in fluid communication with said turbine housing interior, and
      a wall separating said first volute from said second volute, wherein said wall has a first wall surface facing said turbine housing axis; and
   a vane ring coupled to said turbine housing and disposed in said turbine housing interior between said first and second volutes and around said turbine wheel, wherein said vane ring comprises a vane divider wall further separating said first volute from said second volute, wherein said vane divider wall has a vane divider surface facing said first wall surface, wherein said vane ring comprises a plurality of vanes coupled to said vane divider wall, and wherein said plurality of vanes are fixed to said vane divider wall; and
   a pin coupled to said vane ring and said turbine housing for preventing rotation of said vane ring with respect to said turbine housing.
Embodiment 44: The entryway system as set forth in embodiment 43, wherein said pin is coupled to said vane divider wall.
Embodiment 45: The entryway system as set forth in any one of embodiments 43 and 43, wherein vane ring further comprises an outer circumferential ring coupled to said vane divider wall, and wherein said pin is coupled to at least one of said vane divider wall and said outer circumferential ring of said vane ring and said turbine housing for preventing rotation of said vane ring with respect to said turbine housing.
Embodiment 46: The entryway system as set forth in any one of embodiments 43-45, wherein said pin extends parallel with respect to said turbine housing axis.
Embodiment 47: The entryway system as set forth in embodiment 43-46, wherein said pin extends perpendicular with respect to said turbine housing axis.
Embodiment 48: The entryway system as set forth in any one of embodiments 43-47, wherein said turbine housing defines a turbine housing slot, and wherein said pin is disposed in said turbine housing slot.
Embodiment 49: The entryway system as set forth in any one of embodiments 43-48, wherein said vane divider wall defines a divider slot, and wherein said pin is disposed in said divider slot.
Embodiment 50: The entryway system as set forth in any one of embodiments 43-49, wherein said outer circumferential ring defines an outer ring slot, and wherein said pin is disposed in said outer ring slot.
Embodiment 51: The entryway system as set forth in any one of embodiments 43-50, wherein said wall comprises a tongue, with said tongue presenting said first wall surface, and wherein said pin is adjacent said first wall surface such that said pin is configured to be a leading edge of one of said vanes.
Embodiment 52: The entryway system as set forth in embodiment 43, wherein said pin is further defined as a first pin, and further comprising a second pin, wherein said first pin is coupled to said vane divider wall and said turbine housing, and wherein said second pin is coupled to said outer circumferential ring and said turbine housing.
Embodiment 53: The entryway system as set forth in embodiment 52, wherein said vane divider wall defines a divider slot and said turbine housing defines a first turbine housing slot, and wherein said first pin is disposed in said divider slot and said first turbine housing slot.
Embodiment 54: The entryway system as set forth in embodiment 53, wherein said outer circumferential ring defines an outer vane ring slot and said turbine housing defines a second turbine housing slot, and wherein said second pin is disposed in said outer vane ring slot and said second turbine housing slot.
Embodiment 55: The entryway system as set forth in any one of embodiments 45-54, wherein said inner circumferential ring and said outer circumferential ring are integral with one another.
Embodiment 56: The entryway system as set forth in any one of embodiments 45-54, wherein said inner circumferential ring and said outer circumferential ring are separate from one another.
Embodiment 57: The entryway system as set forth in any one of embodiments 45-56, wherein said divided volute turbocharger is further defined as a twin volute turbocharger.
Embodiment 58: An entryway system comprising:
   a divided volute turbocharger for receiving exhaust gas from an internal combustion engine and for delivering compressed air to the internal combustion engine, the internal combustion engine including a first set of cylinders and a second set of cylinders, with a relative pulse of the exhaust gas delivered from the first and second set of cylinders being generally equal for each exhaust stroke, said divided volute turbocharger comprising:
      a turbine housing comprising a turbine housing interior adapted to receive a turbine wheel having a plurality of turbine blades, with said turbine housing extending along a turbine housing axis,
      a first volute adapted for fluid communication with the internal combustion engine and said turbine housing interior for delivering exhaust gas from the first set of cylinders to said turbine housing interior,
      a second volute adapted for fluid communication with the internal combustion engine and said turbine housing interior for delivering exhaust gas from the second set of cylinders to said turbine housing interior independently of said first volute,
      a turbine housing outlet in fluid communication with said turbine housing interior, and
      a wall separating said first volute from said second volute, wherein said wall has a first wall surface facing said turbine housing axis; and
   a vane ring coupled to said turbine housing and disposed in said turbine housing interior between said first and second volutes and around said turbine wheel, wherein said vane ring comprises a vane divider wall further separating said first volute from said second volute, wherein said vane divider wall has a vane divider surface facing said first wall surface, wherein said vane ring comprises a plurality of vanes coupled to said vane divider wall, wherein said plurality of vanes are fixed to said vane divider wall, and wherein said vane ring further comprises an outer circumferential ring coupled to said vane divider wall;
   wherein said outer circumferential ring and said vane divider wall are separate components from one another.
Embodiment 59: The entryway system as set forth in embodiment 58, wherein said plurality of vanes are further defined as a first plurality of vanes protruding from said vane divider wall and into said first volute, and a second plurality of vanes protruding from said vane divider wall and into said second volute.
Embodiment 60: The entryway system as set forth in embodiment 59, wherein said first plurality of vanes, said second plurality of vanes, and said vane divider wall are integral with one another.
Embodiment 61: An entryway system comprising:
   a divided volute turbocharger for receiving exhaust gas from an internal combustion engine and for delivering compressed air to the internal combustion engine, the internal combustion engine including a first set of cylinders and a second set of cylinders, with a relative pulse of the exhaust gas delivered from the first and second set of cylinders being generally equal for each exhaust stroke, said divided volute turbocharger comprising:
      a turbine housing comprising a turbine housing interior adapted to receive a turbine wheel having a plurality of turbine blades, with said turbine housing extending along a turbine housing axis,
      a first volute adapted for fluid communication with the internal combustion engine and said turbine housing interior for delivering exhaust gas from the first set of cylinders to said turbine housing interior,
      a second volute adapted for fluid communication with the internal combustion engine and said turbine housing interior for delivering exhaust gas from the second set of cylinders to said turbine housing interior independently of said first volute,
      a turbine housing outlet in fluid communication with said turbine housing interior, and
      a wall separating said first volute from said second volute, wherein said wall has a first wall surface facing said turbine housing axis; and
   a vane ring coupled to said turbine housing and disposed in said turbine housing interior between said first and second volutes and around said turbine wheel, wherein said vane ring comprises a vane divider wall further separating said first volute from said second volute, wherein said vane divider wall has a vane divider surface facing said first wall surface, wherein said vane ring comprises a plurality of vanes coupled to said vane divider wall, wherein said plurality of vanes are fixed to said vane divider wall, and wherein said vane ring further comprises an outer circumferential ring coupled to said vane divider wall;
   wherein said outer circumferential ring and said vane divider wall are integral with one another.
Embodiment 62: The entryway system as set forth in embodiment 61, wherein said plurality of vanes are further defined as a first plurality of vanes protruding from said vane divider wall and into said first volute, and a second plurality of vanes protruding from said vane divider wall and into said second volute.
Embodiment 63: The entryway system as set forth in embodiment 62, wherein said plurality of vanes, said vane divider wall, and said outer circumferential ring are integral with one another.
Embodiment 64: An entryway system comprising:
   a divided volute turbocharger for receiving exhaust gas from an internal combustion engine and for delivering compressed air to the internal combustion engine, the internal combustion engine including a first set of cylinders and a second set of cylinders, with a relative pulse of the exhaust gas delivered from the first and second set of cylinders being generally equal for each exhaust stroke, said divided volute turbocharger comprising:
      a turbine housing comprising a turbine housing interior adapted to receive a turbine wheel having a plurality of turbine blades, with said turbine housing extending along a turbine housing axis,
      a first volute adapted for fluid communication with the internal combustion engine and said turbine housing interior for delivering exhaust gas from the first set of cylinders to said turbine housing interior,
      a second volute adapted for fluid communication with the internal combustion engine and said turbine housing interior for delivering exhaust gas from the second set of cylinders to said turbine housing interior independently of said first volute,
      a turbine housing outlet in fluid communication with said turbine housing interior, and
      a wall separating said first volute from said second volute, wherein said wall has a first wall surface facing said turbine housing axis; and
   a vane ring coupled to said turbine housing and disposed in said turbine housing interior between said first and second volutes and around said turbine wheel, wherein said vane ring comprises a vane divider wall further separating said first volute from said second volute, wherein said vane divider wall has a vane divider surface facing said first wall surface, wherein said vane ring comprises a plurality of vanes coupled to said vane divider wall, wherein said plurality of vanes are fixed to said vane divider wall, and wherein said vane ring further comprises an outer circumferential ring coupled to said vane divider wall;
   wherein said turbine housing has a first turbine housing surface engaged with said inner circumferential ring and facing a first direction with respect to said turbine housing axis, wherein said outer circumferential ring has a second surface facing a second direction opposite said first direction with respect to said turbine housing axis, and wherein at least one of said first turbine housing surface and said second surface of said outer circumferential ring are angled with respect to said turbine housing axis.
Embodiment 65: The entryway system as set forth in embodiment 64, wherein said first turbine housing surface is angled with respect to said turbine housing axis.
Embodiment 66: The entryway system as set forth in any one of embodiments 64 and 65, wherein said second surface of said outer circumferential ring is angled with respect to said turbine housing axis.
Embodiment 67: An entryway system comprising:
   a divided volute turbocharger for receiving exhaust gas from an internal combustion engine and for delivering compressed air to the internal combustion engine, the internal combustion engine including a first set of cylinders and a second set of cylinders, with a relative pulse of the exhaust gas delivered from the first and second set of cylinders being generally equal for each exhaust stroke, said divided volute turbocharger comprising:
      a turbine housing comprising a turbine housing interior adapted to receive a turbine wheel having a plurality of turbine blades, with said turbine housing extending along a turbine housing axis,
      a first volute adapted for fluid communication with the internal combustion engine and said turbine housing interior for delivering exhaust gas from the first set of cylinders to said turbine housing interior,
      a second volute adapted for fluid communication with the internal combustion engine and said turbine housing interior for delivering exhaust gas from the second set of cylinders to said turbine housing interior independently of said first volute,
      a turbine housing outlet in fluid communication with said turbine housing interior, and
      a wall separating said first volute from said second volute, wherein said wall has a first wall surface facing said turbine housing axis;
   a vane ring coupled to said turbine housing and disposed in said turbine housing interior between said first and second volutes and around said turbine wheel, wherein said vane ring comprises a vane divider wall further separating said first volute from said second volute, wherein said vane divider wall has a vane divider surface facing said first wall surface, and wherein said vane ring comprises a plurality of vanes coupled to said vane divider wall; and
   a pin coupled to said vane ring and said turbine housing for preventing rotation of said vane ring with respect to said turbine housing;
   wherein said wall comprises a tongue, with said tongue presenting said first wall surface, and wherein said pin is adjacent said first wall surface such that said pin is configured to be a leading edge of one of said vanes.
Embodiment 68: The entryway system as set forth in embodiment 67, wherein said pin extends parallel with respect to said turbine housing axis.
Embodiment 69: The entryway system as set forth in any one of embodiments 67 and 68, wherein said vane ring further comprises an outer circumferential ring coupled to said vane divider wall.
Embodiment 70: The entryway system as set forth in any one of embodiments 67-69, wherein said plurality of vanes are further defined as a first plurality of vanes protruding from said vane divider wall and into said first volute, and a second plurality of vanes protruding from said vane divider wall and into said second volute.
Embodiment 71: The entryway system as set forth in embodiment 70, wherein said first plurality of vanes, said second plurality of vanes, and said vane divider wall are integral with one another.
Embodiment 72: The entryway system as set forth in any one of embodiments 69-71, wherein said plurality of vanes, said vane divider wall, and said outer circumferential ring are integral with one another.
Embodiment 73: The entryway system as set forth in any one of embodiments 67-72, wherein said pin is coupled to said vane divider wall.
Embodiment 74: The entryway system as set forth in embodiment 73, wherein said pin is coupled to at least one of said vane divider wall and said outer circumferential ring of said vane ring and said turbine housing for preventing rotation of said vane ring with respect to said turbine housing.
Embodiment 75: The entryway system as set forth in any one of embodiments 67-74, wherein said turbine housing defines a turbine housing slot, and wherein said pin is disposed in said turbine housing slot.
Embodiment 76: The entryway system as set forth in any one of embodiments 67-75, wherein said vane divider wall defines a divider slot, and wherein said pin is disposed in said divider slot.
Embodiment 77: The entryway system as set forth in any one of embodiments 67-76, wherein said outer circumferential ring defines an outer ring slot, and wherein said pin is disposed in said outer ring slot.
Embodiment 78: The entryway system as set forth in any one of embodiments 67-77, wherein said pin is further defined as a first pin, and further comprising a second pin, wherein said first pin is coupled to said vane divider wall and said turbine housing, and wherein said second pin is coupled to said outer circumferential ring and said turbine housing.
Embodiment 79: The entryway system as set forth in embodiment 78, wherein said outer circumferential ring defines an outer vane ring slot and said turbine housing defines a second turbine housing slot, and wherein said second pin is disposed in said outer vane ring slot and said second turbine housing slot.
Embodiment 80: The entryway system as set forth in any one of embodiments 69-79, wherein said outer circumferential ring and said vane divider wall are integral with one another.
Embodiment 81: The entryway system as set forth in embodiment 80, wherein said plurality of vanes, said vane divider wall, and said outer circumferential ring are integral with one another.
Embodiment 82: The entryway system as set forth in any one of embodiments 69-79, wherein said outer circumferential ring and said vane divider wall are separate components from one another.

What is claimed is:

1. An entryway system comprising:
a divided volute turbocharger for receiving exhaust gas from an internal combustion engine and for delivering compressed air to the internal combustion engine, the internal combustion engine including a first set of cylinders and a second set of cylinders, with a relative pulse of the exhaust gas delivered from the first and second set of cylinders being generally equal for each exhaust stroke, said divided volute turbocharger comprising:
a turbine housing comprising a turbine housing interior adapted to receive a turbine wheel having a plurality of turbine blades, with said turbine housing extending along a turbine housing axis,
a first volute adapted for fluid communication with the internal combustion engine and said turbine housing interior for delivering exhaust gas from the first set of cylinders to said turbine housing interior,
a second volute adapted for fluid communication with the internal combustion engine and said turbine housing interior for delivering exhaust gas from the second set of cylinders to said turbine housing interior independently of said first volute,
a turbine housing outlet in fluid communication with said turbine housing interior, and
a wall separating said first volute from said second volute, wherein said wall has a first wall surface facing said turbine housing axis; and
a vane ring coupled to said turbine housing and disposed in said turbine housing interior between said first and second volutes and around said turbine wheel, wherein said vane ring comprises a vane divider wall further separating said first volute from said second volute, wherein said vane divider wall has a vane divider surface facing said first wall surface, and wherein said vane ring comprises a plurality of vanes coupled to said vane divider wall;
wherein said first wall surface of said wall and said vane divider surface of said vane divider wall define a restriction path between one another with respect to said turbine housing axis, and wherein at least a portion of said restriction path is non-parallel to said turbine housing axis such that leakage of exhaust gas from one of said first and second volutes to the other of said first and second volutes is reduced.

2. The entryway system as set forth in claim 1, wherein said restriction path has a tortuous configuration with respect to said turbine housing axis.

3. The entryway system as set forth in claim 1, wherein said restriction path has a curved configuration with respect to said turbine housing axis.

4. The entryway system as set forth in claim 1, wherein said restriction path defined between said vane divider surface and said first wall surface of said wall has a first restriction path adjacent said first volute and extending parallel with respect to said turbine housing axis, a second restriction path adjacent said second volute and extending parallel with respect to said turbine housing axis, and a third restriction path extending from said first restriction path to said second restriction path.

5. The entryway system as set forth in claim 4, wherein said third restriction path defines a first angle with said first restriction path and defines a second angle with said second restriction path, and wherein said first and second angles are acute with respect to said turbine housing axis.

6. The entryway system as set forth in claim 1, wherein said restriction path is defined 360 degrees about said turbine housing axis.

7. The entryway system as set forth in claim 1, wherein said vane ring further comprises an outer circumferential ring coupled to said vane divider wall, and wherein said outer circumferential ring and said vane divider wall are integral with one another.

8. The entryway system as set forth in claim 1, wherein said vane ring further comprises an outer circumferential ring coupled to said vane divider wall, and wherein said outer circumferential ring and said vane divider wall are separate components from one another.

9. The entryway system as set forth in claim 1, wherein said plurality of vanes are further defined as a first plurality of vanes protruding from said vane divider wall and into said first volute, and a second plurality of vanes protruding from said vane divider wall and into said second volute.

10. The entryway system as set forth in claim 9, wherein said first plurality of vanes, said second plurality of vanes, and said vane divider wall are integral with one another.

11. The entryway system as set forth in claim 9, wherein said plurality of vanes, said vane divider wall, and said outer circumferential ring are integral with one another.

12. The entryway system as set forth in claim 1 further comprising a pin coupled to said vane ring and said turbine housing for preventing rotation of said vane ring with respect to said turbine housing.

13. The entryway system as set forth in claim 12, wherein said pin is coupled to said vane divider wall.

14. The entryway system as set forth in claim 12, wherein said pin is coupled to at least one of said vane divider wall and said outer circumferential ring of said vane ring and said turbine housing for preventing rotation of said vane ring with respect to said turbine housing.

15. The entryway system as set forth in claim 1, wherein said wall comprises a tongue, with said tongue presenting said first wall surface, and wherein said pin is adjacent said first wall surface such that said pin is configured to be a leading edge of one of said vanes.

16. The entryway system as set forth in claim 1, wherein said turbine housing has a first turbine housing surface engaged with said vane ring and facing a first direction with respect to said turbine housing axis, wherein said outer circumferential ring has a second surface facing a second direction opposite said first direction with respect to said turbine housing axis, and wherein at least one of said first turbine housing surface and said second surface of said outer circumferential ring are angled with respect to said turbine housing axis.

17. An entryway system comprising:
a divided volute turbocharger for receiving exhaust gas from an internal combustion engine and for delivering compressed air to the internal combustion engine, the internal combustion engine including a first set of cylinders and a second set of cylinders, with a relative pulse of the exhaust gas delivered from the first and second set of cylinders being generally equal for each exhaust stroke, said divided volute turbocharger comprising:
a turbine housing comprising a turbine housing interior adapted to receive a turbine wheel having a plurality of turbine blades, with said turbine housing extending along a turbine housing axis,
a first volute adapted for fluid communication with the internal combustion engine and said turbine housing interior for delivering exhaust gas from the first set of cylinders to said turbine housing interior,
a second volute adapted for fluid communication with the internal combustion engine and said turbine housing interior for delivering exhaust gas from the second set of cylinders to said turbine housing interior independently of said first volute,
a turbine housing outlet in fluid communication with said turbine housing interior, and
a wall separating said first volute from said second volute, wherein said wall has a first wall surface facing said turbine housing axis; and
a vane ring coupled to said turbine housing and disposed in said turbine housing interior between said first and second volutes and around said turbine wheel, wherein said vane ring comprises a vane divider wall further separating said first volute from said second volute, wherein said vane divider wall has a vane divider surface facing said first wall surface, wherein said vane ring comprises a plurality of vanes coupled to said vane divider wall, and wherein said plurality of vanes are fixed to said vane divider wall; and
a pin coupled to said vane ring and said turbine housing for preventing rotation of said vane ring with respect to said turbine housing.

18. The entryway system as set forth in claim 17, wherein said wall comprises a tongue, with said tongue presenting said first wall surface, and wherein said pin is adjacent said first wall surface such that said pin is configured to be a leading edge of one of said vanes.

19. An entryway system comprising:
a divided volute turbocharger for receiving exhaust gas from an internal combustion engine and for delivering compressed air to the internal combustion engine, the internal combustion engine including a first set of cylinders and a second set of cylinders, with a relative pulse of the exhaust gas delivered from the first and second set of cylinders being generally equal for each exhaust stroke, said divided volute turbocharger comprising:
a turbine housing comprising a turbine housing interior adapted to receive a turbine wheel having a plurality of turbine blades, with said turbine housing extending along a turbine housing axis,
a first volute adapted for fluid communication with the internal combustion engine and said turbine housing interior for delivering exhaust gas from the first set of cylinders to said turbine housing interior,
a second volute adapted for fluid communication with the internal combustion engine and said turbine housing interior for delivering exhaust gas from the second set of cylinders to said turbine housing interior independently of said first volute,
a turbine housing outlet in fluid communication with said turbine housing interior, and
a wall separating said first volute from said second volute, wherein said wall has a first wall surface facing said turbine housing axis;
a vane ring coupled to said turbine housing and disposed in said turbine housing interior between said first and second volutes and around said turbine wheel, wherein said vane ring comprises a vane divider wall further separating said first volute from said second volute, wherein said vane divider wall has a vane divider surface facing said first wall surface, and wherein said vane ring comprises a plurality of vanes coupled to said vane divider wall; and
a pin coupled to said vane ring and said turbine housing for preventing rotation of said vane ring with respect to said turbine housing;
wherein said wall comprises a tongue, with said tongue presenting said first wall surface, and wherein said pin is adjacent said first wall surface such that said pin is configured to be a leading edge of one of said vanes.

20. The entryway system as set forth in claim 19, wherein said pin extends parallel with respect to said turbine housing axis.
